(19) United States
(12) Patent Application Publication
(10) Pub. No.: US 2013/0110524 A1
(43) Pub. Date: May 2, 2013

(54) MANAGEMENT OF PETROLEUM RESERVOIR ASSETS USING RESERVES RANKING ANALYTICS

(71) Applicants: Nansen G. Saleri, Houston, TX (US); Robert M. Toronyi, Danville, CA (US)

(72) Inventors: Nansen G. Saleri, Houston, TX (US); Robert M. Toronyi, Danville, CA (US)

(21) Appl. No.: 13/282,272

(22) Filed: Oct. 26, 2011

(51) Int. Cl. G06Q 50/02

(52) U.S. Cl. 705/1.1

(57) ABSTRACT

A method of classifying a petroleum reservoir using a Reservoir Ranking Analysis (RRA™). RRA™ classification includes establishing reservoir classification metrics for each of the following categories: 1) resource size, 2) recovery potential, and 3) profitability. The reservoir is classified based on at least one metric in the profitability classification category, and also based on at least one metric in one or more of the resource size classification category or the recovery potential classification category. Classification of reservoirs can aid in reservoir management, planning, and development.

### CROSS REFERENCE TO RELATED APPLICATIONS

Not Applicable.

### BACKGROUND OF THE INVENTION

1. The Field of the Invention

The invention is in the field of petroleum reservoir asset management, more particularly in analyzing and classifying petroleum reservoir assets based on technical and economic metrics.

2. The Relevant Technology

Petroleum is a critical fuel source and is the life blood of modern society. There is tremendous economic opportunity in finding and extracting petroleum. Due to a variety of technical and geological obstacles, it is typically impossible to recover all of the petroleum contained in a reservoir. With advancing technologies and increasing economic incentive due to higher crude oil prices, the average petroleum reservoir recovery rate can now approach about 35%. While this represents a significant increase in average total petroleum recovery in recent years, it also means that about 65% of the petroleum found in a typical reservoir remains unrecoverable from an economic and/or technical standpoint.

With regard to productivity, operators typically analyze each individual well to determine the rate of petroleum extraction, or well productivity. However, operators typically do not understand how to evaluate and understand aggregate well activity and productivity for an entire reservoir or oil field, or how to evaluate well activity and productivity across a plurality of reservoirs or oil fields.

Given the high cost of exploration, dwindling opportunities to find new petroleum reservoirs, and the rising cost of petroleum as a commodity, there currently exists a tremendous economic opportunity for organizations to significantly increase both short-term and long-term production across their petroleum reservoirs. The fact that a majority of petroleum in a typical reservoir remains unrecoverable in spite of the high marginal economic benefits of increasing recovery means that there do not currently exist technologically and/or economically predictable ways of increasing recovery.

While the technology may, in fact, exist to increase current production and/or increase total long-term recovery of an organization's petroleum reservoirs, an impediment to implementing an intelligent long-term plan for maximizing current output, extending the life of each reservoir, and increasing total recovery across reservoirs is inadequate knowledge of where to focus the organization's limited resources for optimal production. For example, while a particular reservoir may underperform relative to other reservoirs, which might lead some to neglect further development of the reservoir, the reservoir may, in fact, contain much larger quantities of recoverable petroleum but be under-producing simply due to poor management. Furthermore, organizations may waste resources developing some reservoirs, in which the production gains achieved are disproportionately small compared to the developmental resources expended. The inability to properly diagnose on which reservoirs to focus further development and resources, and to implement an intelligent recovery plan can result in diminished short-term productivity and long-term recovery across the organization's petroleum reservoirs.

In general, those who operate production facilities typically focus on oil well maintenance at an individual reservoir level, and may even implement the latest technologies for maximizing well output at the reservoir. They fail, however, to understand the total picture of health and longevity of the reservoir, and how the reservoir performs relative to other reservoirs, both on a short-term and on a long-term basis. Wells are difficult and expensive to drill and operate. Once a given number of wells are in place, it may be economically infeasible to drill more wells in order to increase reservoir production (i.e., the marginal cost may exceed the marginal benefit). Moreover, there may be no apparent reason to shut down a producing well even though doing so might actually increase short-term production and improve long-term recovery. The knowledge of when and why to shut down or alter a producing well and/or properly construct a new well often eludes even the most experienced producers and well managers. The failure to properly manage existing wells and/or place and construct new wells can increase capital costs while reducing production and recovery.

One impediment to maximizing production and recovery of an organization's petroleum reservoirs is the inability to gather, intelligently analyze and correctly understand the relevant data about the reservoirs. Diagnosing the health of petroleum reservoirs is not straightforward and is much like trying to decipher the health of a human body, but at a location far beneath the earth or ocean. Moreover, the available data may take years to accumulate and assess, yet may be dynamically changing, making it difficult to formulate and implement an economically and/or technically feasible plan of action. The result is continuing low short-term productivity and long-term recovery of petroleum from the petroleum reservoirs.

### BRIEF SUMMARY OF THE INVENTION

The present invention relates to reservoir management, and more particularly to methods, systems, and computer program products for analyzing and classifying petroleum reservoirs into tiers in a manner that captures and ranks the petroleum reservoirs in terms of opportunities for petroleum exploitation. The concept may be called “Reserve Ranking Analytics” or “RRA™”. RRA™ is a systematic methodology that broadly classifies petroleum assets into tiers of opportunity using techno-economic metrics, and can aid organizations in achieving maximum sustainable hydrocarbon output, reserves appreciation, and capital efficiency. RRA™ is comprised of a unique presentation or analysis of metrics, indices and measures as they relate to the remaining petroleum in place at each reservoir (i.e., potential prize or remaining resource size), the estimated ultimate recovery potential of each reservoir, and profitability of each reservoir. By providing an empirical classification/ranking of reservoirs, with a focus on capturing top opportunities for petroleum exploitation, RRA™ can be used to make sense out of complex data and to evaluate the quality of alternative solutions in a standardized internally consistent manner.

The effectiveness of RRA™ is based on its unique combination of metrics which emphasize the fundamental areas of reservoir performance while filtering out non-critical parameters which only add noise to the evaluation process. The RRA™ classification can be used in the allocation of limited reservoir developmental resources, ensuring that an organization's reserves are efficiently exploited, both in the short term and in the long term.

RRA™ can also be used as part of a more comprehensive reservoir evaluation system and methodology known as Reservoir Competency Asymmetric Assessment™ (or RCAA™), which is discussed more fully below in the Detailed Description.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 schematically illustrates exemplary computer-implemented or controlled architecture that can be used to gather, analyze and/or display data gathered from and about petroleum reservoirs;

FIG. 2 schematically illustrates an exemplary classification component that can be used to classify petroleum reservoirs;

FIG. 3 is a flow diagram that illustrates exemplary acts in a method for performing a Reserve Ranking Analytics (RRA™) classification of petroleum reservoirs; and

FIG. 4 is as flow chart for performing a Reserve Ranking Analytics (RRA™) classification of petroleum reservoirs.

### DETAILED DESCRIPTION OF THE PREFERRED EMBODIMENTS

### I. Introduction

As discussed above, Reserve Ranking Analytics (RRA™) is a systematic methodology that broadly classifies petroleum assets into tiers of opportunity using techno-economic metrics, and can aid organizations in achieving maximum sustainable hydrocarbon output, reserves appreciation, and capital efficiency. It involves a unique presentation or analysis of metrics, indices and measures as they relate to the remaining petroleum in place at each reservoir (i.e., potential prize or remaining resource size), the estimated ultimate recovery potential of each reservoir, and profitability of each reservoir.

Implementation of RRA™ involves an analysis and classification of each reservoir according to the relative risk and impact of future incremental investments, using one or more filtering metrics or indicators. In this way, RRA™ can classify reservoirs in a manner that can highlight opportunities for petroleum extraction, gaps in current extraction practices, and preferred trends in capital allocations. As discussed in greater detail later, the filtering metrics/indicators can include (i) resource size, characterized by one or more of the Oil Initially In Place (OIIP), the remaining Oil In Place (OIP), or future oil to be recovered; (ii) recovery potential, characterized by one or more of the estimated ultimate recovery, a Geo-Technical Index (GTI™), or a Reservoir Development Quality Index (RDQI™); or (iii) profitability, characterized by one or more of an Internal Rate of Return (IRR), a Return of Revenues (ROR), or a Net Present Value (NPV).

### II. Use of RRA™ as Part of RCAA™

Reserve Ranking Analytics (RRA™) can be used in conjunction with, and as a component of, a larger, more comprehensive system for assessing petroleum reservoir competency. One example of a larger, more comprehensive system developed by the inventors is known as Reservoir Competency Asymmetric Assessment™ (or RCAA™) a description of which is set forth in U.S. Pat. No. 7,963,327, issued Jun. 21, 2011, and entitled “METHOD FOR DYNAMICALLY ASSESSING PETROLEUM RESERVOIR COMPETENCY AND INCREASING PRODUCTION AND RECOVERY THROUGH ASYMMETRIC ANALYSIS OF PERFORMANCE METRICS,” which is incorporated herein in its entirety by reference.

By way of background, RCAA™ includes several closely interrelated sub-methods or modules that are employed in concert and sequentially. These methods or modules can be used in forming metrics and indicators regarding petroleum reserves that used as part of the RRA™, and knowledge gained as part of an RRA™ can be further applied to an iterative application of the RCAA™ of the petroleum reserves. The methods or modules are (i) analyzing and diagnosing the specific and unique features of a reservoir (i.e., its “DNA”) using targeted metrics, of which the Recovery Deficiency Indictor™ (RDI™) is one of the components, (ii) designing a recovery plan for maximizing or increasing current production and ultimate recovery (e.g., increasing recoverable petroleum reserves) from the petroleum reservoir, (iii) implementing the recovery plan so as to increase current production and ultimate recovery of petroleum from the reservoir, and (iv) monitoring or tracking the performance of the petroleum reservoir using targeted metrics and making adjustments to production parameters, as necessary, to maintain desired productivity and recovery.

RCAA™ and RRA™ each rely on intense knowledge gathering techniques, which can include taking direct measurements of the physics, geology, and other unique conditions and aspects of the reservoir and, where applicable, considering the type, number, location and efficacy of any wells that are servicing, or otherwise associated with, the reservoir (e.g., producing wells, dead wells, and observation wells), analyzing the present condition or state of the reservoir using asymmetric weighting of different metrics, and prognosticating future production, recovery and other variables based on a comprehensive understanding of the specific reservoir DNA coupled with the asymmetric weighting and analysis of the data. In some cases, the gathered information may relate to measurements and data generated by others (e.g., the reservoir manager).

In general, RCAA™ is an assessment process which guides both the planning and implementation phases of petroleum recovery. All hydrocarbon assets carry an individual “DNA” reflective of their subsurface and surface features. RCAA™ is an enabling tool for developing and applying extraction methods which are optimally designed to the specifications of individual hydrocarbon reservoirs. Its main value is assisting in the realization of incremental barrels of reserves and production over and above levels being achieved using standard industry techniques. This, in turn, may reduce long-term capital and operating expenses.

According to one embodiment, implementation of RCAA™ spans six interweaving and interdependent tracks: i) Knowledge Systems; ii) Q6 Surveys; iii) Deep Insight Workshops; iv) Q-Diagnostics; v) Gap Analysis; and vi) Plan of Action. The information gathered from these tracks is integrated using modern knowledge-sharing mediums including web-based systems and communities of practice. While the overall business model of RCAA™ includes both technological and non-technological means for gathering the relevant information, the method cannot be implemented without the use of physical processes and machinery for gathering key information. Moreover, implementing a plan of action involves computerized monitoring of well activity. And enhanced reservoir performance results in a physical transformation of the reservoir itself.

Performing a Reserve Ranking Analytics (RRA™) classification similarly involves physical processes and machinery for gathering key information. Converting such information, which relates to both the geological characteristics of the reservoir as well as operational attributes of the petroleum recovery plan, into a Reserve Ranking Analytics (RRA™) classification is a transformation of essentially physical data into a diagnostic determination or score of petroleum reservoirs. To the extent that such transformations of data are carried out using a computer system programmed to perform a Reserve Ranking Analytics (RRA™) classification from the underlying data, more particularly using a processor and system memory, such a computer system is itself a machine.

Because the subsurface plumbing of the reservoir is not homogeneous, it will often be necessary to statistically weight some data points more than others in order to come up with a more accurate assessment of the reservoir. In some cases, outlier data points may simply be anomalies and can be ignored or minimized. In other cases, outliers that show increased recovery efficiency for one or more specific regions of the reservoir which may themselves be the ideal and indicate that extraction techniques used in other, less productive regions of the reservoir need improvement.

Physical processes that utilize machinery to gather data include, for example, 1) coring to obtain down hole rock samples (both conventional and special coring), 2) taking down hole fluid samples of oil, water and gas, 3) measuring initial pressures from radio frequency telemetry or like devices, and 4) determining fluid saturations from well logs (both cased hole and open hole). Moreover, once a plan of action is implemented and production and/or recovery from the reservoir are increased, the reservoir is transformed from a lower-producing to a higher-producing asset.

Monitoring the performance of the reservoir before, during and/or after implementation of a plan of action involves the use of a computerized system (i.e., part of a “control room”) that receives, analyzes and displays relevant data (e.g., to and/or between one or more computers networked together and/or interconnected by the internet). Examples of metrics that can be monitored include 1) reservoir pressure and fluid saturations and changes with logging devices, 2) well productivity and drawdown with logging devices, fluid profile in production and injection wells with logging devices, and oil, gas and water production and injection rates. Relevant metrics can be transmitted and displayed to recipients using the internet or other network. Web based systems can share such data.

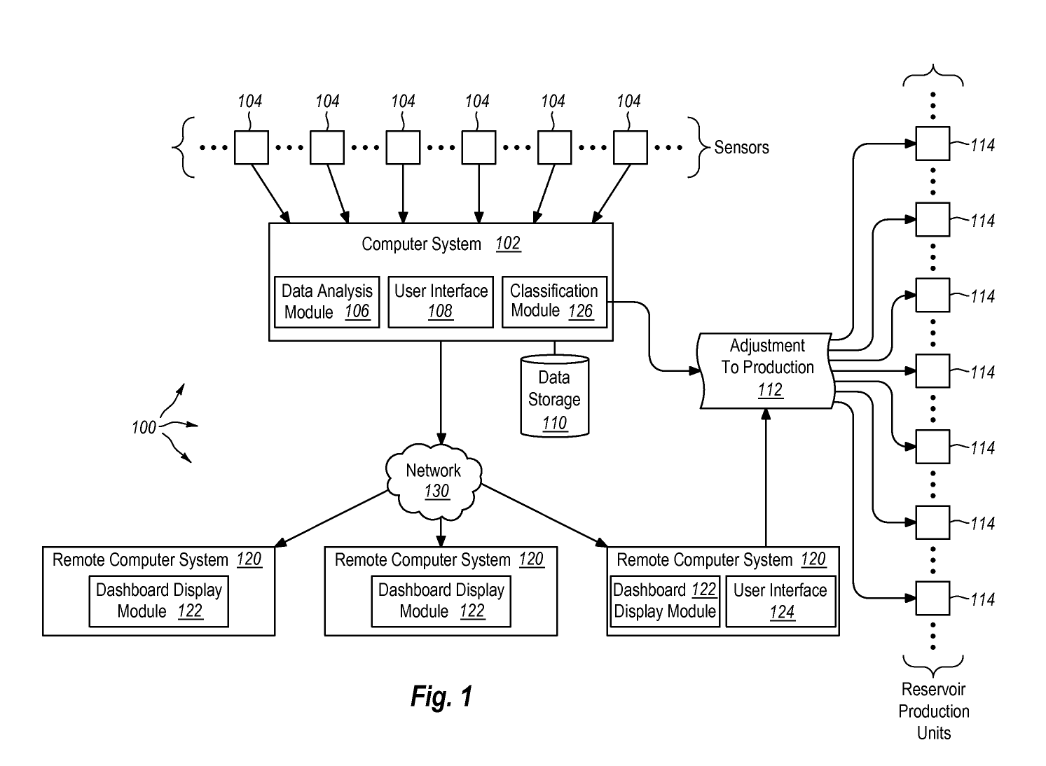

FIG. 1 illustrates an exemplary computer-implemented monitoring and analysis system 100 that monitors reservoir performance, analyzes information regarding reservoir performance, displays dashboard metrics, and optionally provides for computer-controlled modifications to maintain optimal oil well performance. Monitoring and analysis system 100 includes a main data gathering computer system 102 comprised of one or more computers located near a reservoir and linked to reservoir sensors 104. Each computer typically includes at least one processor and system memory. Computer system 102 may comprise a plurality of networked computers (e.g., each of which is designed to analyze a sub-set of the overall data generated by and received from the sensors 104). Reservoir sensors 104 are typically positioned at producing oil well, and may include both surface and sub-surface sensors. Sensors 104 may also be positioned at water injection wells, observation wells, etc. The data gathered by the sensors 104 can be used to generate performance metrics (e.g., leading and lagging indicators of production and recovery), including those which relate to Reserve Ranking Analytics (RRA™). The computer system 102 may therefore include a data analysis module 106 programmed to establish reservoir metrics from the received sensor data. A user interface 108 provides interactivity with a user, including the ability to input data relating to areal displacement efficiency, vertical displacement efficiency, and pore displacement efficiency. Data storage device or system 110 can be used for long term storage of data and metrics generated from the data, including data and metrics relating to Reserve Ranking Analytics (RRA™). A classification module 126 uses reservoir metrics established by the data analysis module 106 to classify reservoirs into one or more of classes or tiers.

According to one embodiment, the computer system 102 can provide for at least one of manual or automatic adjustment to production 112 by reservoir production units 114 (e.g., producing oil wells, water injection wells, gas injection wells, heat injectors, and the like, and sub-components thereof). Adjustments might include, for example changes in volume, pressure, temperature, well bore path (e.g., via closing or opening of well bore branches). The user interface 108 permits manual adjustments to production 112. The computer system 102 may, in addition, include alarm levels or triggers that, when certain conditions are met, provide for automatic adjustments to production 112.

Monitoring system 100 may also include one or more remote computers 120 that permit a user, team of users, or multiple parties to access information generated by main computer system 102. For example, each remote computer 120 may include a dashboard display module 122 that renders and displays dashboards, metrics, or other information relating to reservoir production. Each remote computer 120 may also include a user interface 124 that permits a user to make adjustment to production 112 by reservoir production units 114. Each remote computer 120 may also include a data storage device (not shown).

Individual computer systems within monitoring and analysis system 100 (e.g., main computer system 102 and remote computers 120) can be connected to a network 130, such as, for example, a local area network (“LAN”), a wide area network (“WAN”), or even the Internet. The various components can receive and send data to each other, as well as other components connected to the network. Networked computer systems and computers themselves constitute a “computer system” for purposes of this disclosure.

Networks facilitating communication between computer systems and other electronic devices can utilize any of a wide range of (potentially interoperating) protocols including, but not limited to, the IEEE 802 suite of wireless protocols, Radio Frequency Identification (“RFID”) protocols, ultrasound protocols, infrared protocols, cellular protocols, one-way and two-way wireless paging protocols, Global Positioning System (“GPS”) protocols, wired and wireless broadband protocols, ultra-wideband “mesh” protocols, etc. Accordingly, computer systems and other devices can create message related data and exchange message related data (e.g., Internet Protocol (“IP”) datagrams and other higher layer protocols that utilize IP datagrams, such as, Transmission Control Protocol (“TCP”), Remote Desktop Protocol (“RDP”), Hypertext Transfer Protocol (“HTTP”), Simple Mail Transfer Protocol (“SMTP”), Simple Object Access Protocol (“SOAP”), etc.) over the network.

Computer systems and electronic devices may be configured to utilize protocols that are appropriate based on corresponding computer system and electronic device on functionality. Components within the architecture can be configured to convert between various protocols to facilitate compatible communication. Computer systems and electronic devices may be configured with multiple protocols and use different protocols to implement different functionality. For example, a sensor 104 at an oil well might transmit data via wire connection, infrared or other wireless protocol to a receiver (not shown) interfaced with a computer, which can then forward the data via fast Ethernet to main computer system 102 for processing. Similarly, the reservoir production units 114 can be connected to main computer system 102 and/or remote computers 120 by wire connection or wireless protocol.

Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code.

### III. RRA™ Metrics and Indicators

As indicated, an RRA™ classification can involve the use of one or more metrics and/or indicators. The metrics/indicators serve as filters that broadly classify petroleum assets into different categories or tiers of opportunity. The classifications can, in turn, highlight top opportunities for petroleum extraction, gaps in current extraction practices, preferred trends in capital allocations, etc. The metrics or indicators fall into three primary filtering categories: resource size, recovery potential, and profitability.

A. Resource Size

A first metric or indicator is the “potential prize” or the size of the opportunity for exploitation of a petroleum reservoir. The resource size can be characterized by one or more of an estimate of the “Oil Initially In Place” (OIIP) (i.e., the volume of oil present in the reservoir at the time of discovery), an estimate of the remaining “Oil In Place” (OIP or ROIP), or an estimate of future oil to be recovered. Generally, the OIP encapsulates an unbiased estimate of exploitation opportunities, as it can capture both the current state of reservoir depletion and the maximum upside reserve potential. OIIP may not capture current conditions that a reservoir is in or has gone through, and an estimate of future oil to be recovered is inherently built on assumptions about future exploitation processes.

B. Recovery Potential

A second metric or indicator is the estimated ultimate recovery potential for a reservoir. It can be characterized using one or more of a Geo-Technical Index (GTI™) metric or a Reservoir Development Quality Index (RDQI™) metric.

1. Geo-Technical Index (GTI™)

The GTI™ metric captures the primary geologic complexities which drive recovery efficiency. Inputs include transmissibility, compartmentalization, and depth. Although each reservoir comes with a unique set of challenges and complexities, the GTI™ has the ability to capture the key recovery drivers within each reservoir, for both clastic and carbonate rock types. It can serve as a screening tool. The GTI™ is a linear combination that typically varies from 0 to 100. The GTI™ is defined or determined as follows:

GTI™=nₐ*A+n_{b}*B+n_{c}*C

where:
A=Compartmentalization Factor
B=Transmissibility Index, defined as the permeability-cross-sectional area product divided by distance: kA/L, and ft.
C=Depth Factor, typically varying between 1000 and 10,000 meters
nₙ=Weighting coefficients

The three components of GTI™ (Compartmentalization Factor, Transmissibility Index, and Depth Factor) correlate with an “Estimated Ultimate Recovery Factor” (EURF). Reservoirs that are highly compartmentalized or are discontinuous, either vertically or laterally, often exhibit lower recovery efficiency. Transmissibility accounts for reservoir thickness, net-to-gross, permeability, and fluid viscosity, with high transmissibility correlating with high recovery efficiency. Shallow reservoirs also generally exhibit higher recovery efficiency than deeper reservoirs, because of the time and cost required to drill (hence the ultimate spacing that can be attained), and the time and cost required to monitor and intervene in the reservoir.

Numerous sensitivities on GTI™ can be calculated based on use of different weighting coefficients, which can weight each component (Compartmentalization Factor, Transmissibility Index, and Depth Factor) differently. The different GTI™ sensitivities can then be compared to known benchmarks. For example, some exemplary sensitivities may include:

GTI™_{A}—equal weighting (nₐ=n_{b}=n_{c})

GTI™_{B}—2× transmissibility weighting (n_{b}), 2× depth weighting (n_{c})

GTI™_{c}—3× transmissibility weighting (n_{b})

2. Reservoir Development Quality Index (RDQI™)

The RDQI™ metric captures the primary field and reservoir parameters which drive recovery efficiency. Inputs include the GTI™, crude quality, reserves, well and field performance data, and well drilling costs. It has the ability to identify opportunities for increased investment. The RDQI™ is a linear combination that typically varies from 0 to 100. The RDQI™ is defined or determined as follows:

RDQI™=nₐ*A+n_{b}*B+n_{c}*C+n_{d}*D+nₑ*E

where:
A=the GTI™
B=Crude Quality
C=Reserves
D=Well Productivity Index
E=Drilling Costs
nₙ=Weighting coefficients

The five components of RDQI™ (GTI™, Crude Quality, Reserves, Well Productivity Index, and Drilling Costs) can drive field development decisions, and as a result, their combination correlates with the EURF. The term “Curde Quality” generally describes physical and chemical aspects of the crude oil in the reservoir, including but limited to viscosity, boiling point of components, asphaltene content, sulfur content, metal content, and the like. The term “reserves” relates to estimated recoverable hydrocarbon. The term “well productivity index” is a numeric valve relating to well productivity. The term “drilling costs” is self-explanatory.

Numerous sensitivities on RDQI™ can be calculated based on use of different weighting coefficients, which can weight each component (GTI™, Crude Quality, Reserves, Well Productivity Index, and Drilling Costs) differently. Different sensitivities of RDQI™ can be appropriate for different situations, questions, and comparisons. For example, some exemplary sensitivities may include:
RDQI™_{A}—equal weighting (nₐ=n_{b}=n_{c}=n_{d}=nₑ)
RDQI™_{B}—2 times (2×) reserves weighting (nₑ), 2× well productivity weighting (n_{d})
RDQI™_{c}—3× reserves weighting (nₑ)
RDQI™₁—intensive (nₑ=0)

Some embodiments include a sensitivity, referred to as RDQI™₁, that neglects only intensive field properties by omitting reserves. The RDQI™₁ is useful in analyzing fields when comparisons are made independent of size. The RDQI™₁ can, in some embodiments, apply a triple weighting on GTI™.

C. Profitability

A third metric or indicator is the estimated profitability of a reservoir. It can be characterized using one or more of an Internal Rate of Return (IRR) value for drilled wells, a Return of Revenues (ROR), or a Net Present Value (NPV). For example, the IRR, which is an indicator used throughout the petroleum industry, provides an easily understood means of comparison as between different wells and/or reservoirs. The IRR can represent the rate of growth a field is expected to generate. While the actual rate of return that a given project ends up generating may differ from the estimated IRR rate, a project with a higher IRR value would still likely provide a chance of strong growth. Inasmuch as there may be uncertainties in the computation of IRR for individual wells, normalized values (e.g., a IRRₙ that is normalized according to the maximum and minimum values within the data set) can be used instead of IRR when performing an RRA™ classification.

### IV. Implementation of RRA™

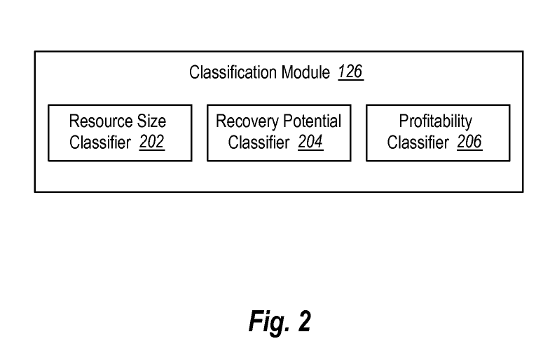

Referring to FIG. 2, illustrated is an embodiment of the classification module 126 introduced in FIG. 1 as part of the computer system 102. As mentioned, the classification module 126 is configured to use metrics established by the data analysis module 106 to classify reservoirs into one or more of classes or tiers. The classification module 126 can include a resource size classifier 202, a recovery potential classifier 204, and a profitability classifier 206. Each of the classifiers (202, 204, and 206) can be configured to work independently of the other classifiers, or can be configured to work in concert with one another.

The resource size classifier 202 is configured to classify reservoirs based on one or more metrics or indicators indicating the size of the opportunity the reservoir represents. For example, the resource size classifier 202 can be configured to classify a reserve based on an estimated OIIP or remaining OIP of the reserve. In some embodiments, the resource size classifier 202 can classify reserves based on generally accepted measures of oil reserves, such as Million Barrels of Oil (MMBO), Billion Stock Tank Barrels (BSTB), and the like.

The recovery potential classifier 204 is configured to classify reservoirs based on one or more recovery potential metrics or indicators. For example, the recovery potential classifier 204 can be configured to classify a reserve based on a calculated GTI™ or RDQI™ score the reserve. In some embodiments, the recovery potential classifier 204 can classify reserves into relative profitability categories, such as high or low, but other classification schemes are also possible.

The profitability classifier 206 is configured to classify reservoirs based on one or more profitability metrics or indicators. For example, the profitability classifier 206 can be configured to classify a reserve based on a calculated IRR, ROR, or NPV of the reserve. In some embodiments, the profitability classifier 206 can classify reserves into relative profitability categories, such as high, medium, and low, but other classification schemes are also possible (e.g., top and bottom reservoirs, express profit amounts, etc.)

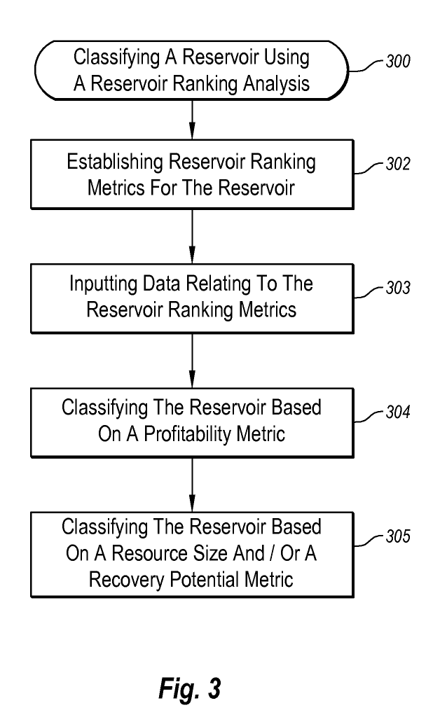

FIG. 3 illustrates a method 300, according to one embodiment, for classifying a petroleum reservoir using a Reservoir Ranking Analysis (RRA™). Method 300 will be described with respect to the components of computer system 102 depicted in FIG. 1, including the components of the classification module 126 depicted in FIG. 2.

Method 300 includes an act 302 of establishing a plurality of reservoir classification metrics for the petroleum reservoir, including at least one metric in each of the following classification categories: 1) resource size, 2) recovery potential, and 3) profitability (act 302). For example, act 302 can include classification module 126 establishing/instantiating a resource size classifier 202, a recovery potential classifier 204, and a profitability classifier 206, which are each configured to classify petroleum reservoirs according to one or more metric. For instance, the resource size classifier 202 can classify reservoirs according to OIIP and/or remaining OIP metrics, the recovery potential classifier 204 can classify reservoirs according GTI™ and/or RDQI™ metrics, and the profitability classifier 206 can classify reservoirs according to IRR, ROR, and/or NPV metrics.

Method 300 also includes an act 303 of inputting into a computing system data relating to the plurality of reservoir classification metrics for the petroleum reservoir, at least some of the data being generated by at least one of (i) measuring a physical property of one or more producing oil wells and/or injector wells of the petroleum reservoir, (ii) taking and analyzing one or more core samples from the petroleum reservoir, or (iii) establishing a relationship between one or more different types of data from (i) or (ii). For example, act 303 can include at least one of sensors 104 inputting data directly into computer system 104 or receiving user input via user interface 108 inputting data into computer system 104. The data can then be analyzed by data analysis module 106 to establish reservoir metrics from the data.

Once the data is in place, method 300 includes an act of 304 classifying the petroleum reservoir as a high, medium, or low profitability reservoir based at least one metric in the profitability classification category (act 304). For example, act 304 can include the profitability classifier 206 classifying the reservoir based upon one or more of IRR, ROR, or NPV metrics. According to one embodiment, at least a portion of act 304 can be performed by a processor at the computing system.

In addition, method 300 includes an act 305 of classifying the petroleum reservoir based on at least one metric in one or more of the resource size classification category or the recovery potential classification category. For example, act 305 can include the resource size classifier 202 classifying the reservoir based upon one or more of OIIP or remaining OIP metrics, and/or the recovery potential classifier 204 classifying the reservoir based upon one or more of GTI™ or RDQI™ metrics. According to one embodiment, at least a portion of act 305 can be performed by a processor at the computing system.

Through resource size classifier 202, recovery potential classifier 204, and profitability classifier 206, method 300 can provide a general framework for classifying the reservoirs. Method 300 can include a variety of additional acts or steps (not shown), such as performing initial filtering on reservoirs to determine whether or not to analyze each reservoir.

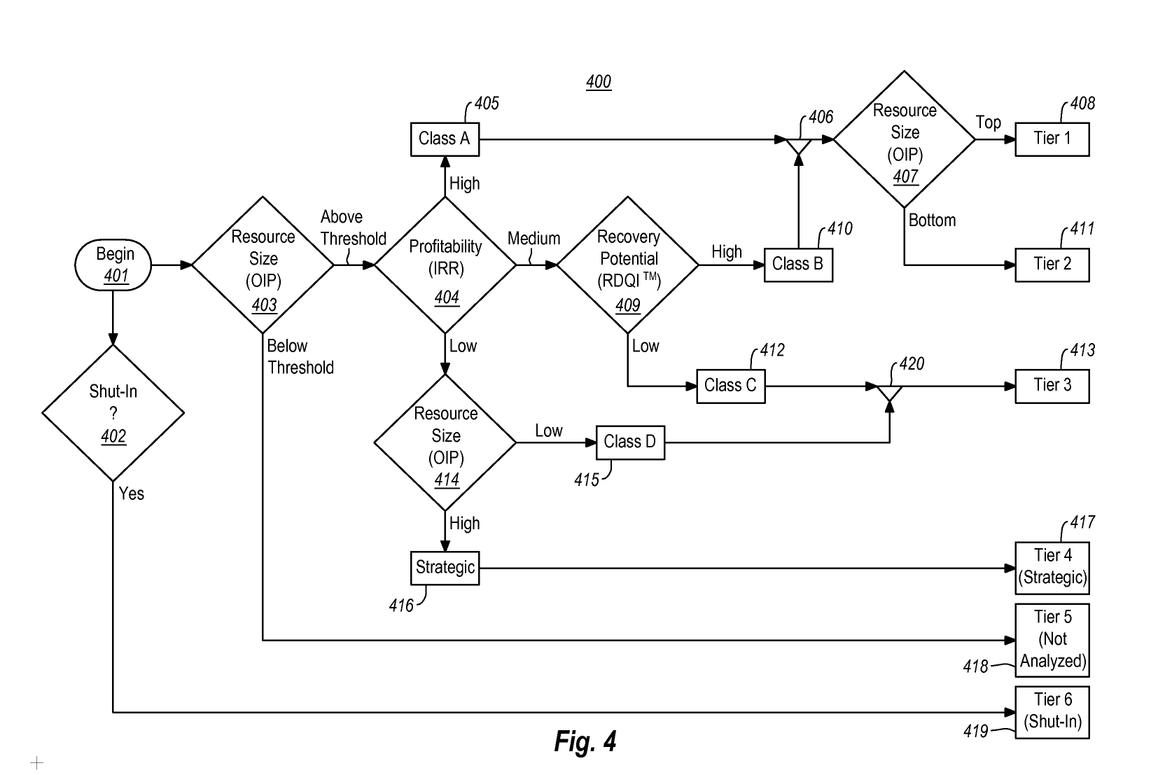

Method 300 (and the classifiers 202, 204, and 206) can be applied in a variety of ways to classify reservoirs into one or more of classes or tiers. For example, FIG. 4 illustrates a flow chart 400 of a specific embodiment of a process for performing an RRA™ classification of petroleum reservoirs, consistent with method 300, which classifies reservoirs into five classes and six tiers. As illustrated, flow chart 400 classifies reservoirs into tiers and/or classes based on one or more of the active status of the reservoir, the resource size of the reservoir (filtered by remaining OIP), the recovery potential of the reservoir (filtered by RDQI™), and the profitability of the reservoir (filtered by IRR for drilling new wells). It will be appreciated by one of skill in the relevant art that the illustrated process can be repeated iteratively, with each iterative step used to classify a different single reservoir, or that the process can be completed on several reservoirs in parallel. According to one embodiment, one or more of the acts associated by flow chart 400 can be performed, at least in part, by means of a computing system.

The classification process can begin at block 401. The classification processes can initially determine whether a subject reservoir is active or shut-in (decision block 402) and/or whether the reservoir is of sufficient size for further analysis (decision block 403). As shown, if it is decided in decision block 402 that the reservoir is shut-in, the reservoir can be classified as a “Tier 6” 419 reservoir. The process can then end for that reservoir and proceed to analyze next reservoir (if any). Additionally or alternatively, the process can determine if the reservoir is of sufficient size to proceed with further analysis. For instance, at decision block 403 (e.g., using resource size classifier 202) the remaining OIP of the reservoir can be used to differentiate the reservoir as one being subject to further analysis (e.g., a resource having a resource size above a given threshold OIP), or as a “Tier 5” 418 reservoir that is not analyzed (e.g., a resource having a resource size below the given threshold OIP). In some embodiments, the threshold OIP used by decision block 403 may be around 200 MMBO, but this figure can vary widely based on overall characteristics of the particular set of reservoirs being classified, and the goals of the classification. It will be appreciated that decision blocks 402 and 403 can be applied in any order, or can be independently applied with, or without, the other.

When the subject reservoir has a resource size that is large enough to trigger analysis, the classification process can apply a profitability filter to the reservoir at decision block 404 (e.g., using profitability classifier 206). As illustrated, the profitability filter can use IRR (e.g., the internal rate of return for drilling new wells) as the classification metric, but as mentioned other profitability measures can also be used (e.g., ROR, NPV). Decision block 404 can, in the illustrated embodiment, classify the reservoir as one having high profitability, medium profitability, or low profitability. In some embodiments, the profitability classifications can be based on a percentage of IRR (e.g., reservoirs having greater than about 150% IRR can be classified as high profitability, reservoirs having between about 21% IRR and about 149% IRR can be classified as medium profitability, and reservoirs having less than about 20% IRR can be classified as low profitability). Again, the particular cutoffs used when performing a profitability classification can vary based on the context and goals of the analysis.

High profitability reservoirs can be classified as “Class A” 405 reservoirs, and may represent fields that are generally low risk, high impact opportunities. These are reservoirs that should provide sustainable petroleum production in the long term, with proper reservoir management. As shown, the “Class A” 405 reservoirs can be combined at combination block 406 with “Class B” 410 reservoirs (which are addressed in more detail later) and can together be subjected to an additional filtering based on resource size (e.g., remaining OIP). At decision block 407 (e.g., using resource size classifier 202), for instance, “Class A” 405 and/or “Class B” 410 reservoirs that have the top resource sizes in the combined classes (the top 20%, for example) can be further classified as “Tier 1” 408 reservoirs. The remaining “Class A” 405 and/or “Class B” 410 reservoirs in the combined classes (the bottom 80%, for example) can be classified as “Tier 2” 411 reservoirs.

Returning to the profitability filter (decision block 404), medium profitability reservoirs can be further classified based on their recovery potential. In the illustrated embodiment, decision block 409 (e.g., using recovery potential classifier 204) can classify the medium profitability reservoirs into higher recovery potential “Class B” 410 reservoirs and lower recovery potential “Class C” 412 reservoirs using RDQI™. For example, reservoirs having a RDQI™ score exceeding about 25 might be considered higher recovery potential reservoirs, and reservoirs having a RDQI™ score below about 25 might be considered lower recovery potential reservoirs. The use of RDQI™ is a choice among several other options (e.g., EURF, GTI™), and like the other filters the particular threshold RDQI™ score used to differentiate reservoirs can vary. “Class B” 410 and “Class C” 412 reservoirs may represent fields that have profitable investment opportunities, but currently perform beneath “Class A” 405 reservoirs. For “Class B” 410 reservoirs, a higher RDQI™ score can indicate, a potential to be elevated to “Class A” 405 status through proper use of advanced technologies and/or best practices in reservoir management. For “Class C” 412 reservoirs, a lower RDQI™ score can indicate that opportunities may be more challenging to secure. As mentioned, “Class B” 410 reservoirs can be combined (at combination block 406) with “Class A” 405 reservoirs and classified as “Tier 1” 408 or “Tier 2” 411 reservoirs based on resource size (decision block 407). Any “Class C” 412 reservoirs can be combined at combination block 420 with “Class D” 415 reservoirs (which are addressed in more detail later) and can together classified as “Tier 3” 413 reservoirs.

Returning again to the profitability filter (decision block 404), low profitability reservoirs can be classified at decision block 414 (e.g., using resource size classifier 202) into “Class D” 415 or “Strategic” 416 classes based on their resource size. In one or more embodiments, for example, reservoirs having more than one Bstb remaining OIP can be classified as “Strategic” 416 reservoirs, while reservoirs having less than one Bstb remaining OIP can be classified as “Class D” 415 reservoirs. “Class D” 415 reservoirs may represent profitable investment opportunities, but those opportunities may be marginal compared to those of other classes. “Strategic” 416 reservoirs may represent less profitable investment opportunities relative to other classes, and may require high efforts in technology, reservoir management, and resource commitments to be elevated to “Class A” 405 reservoirs. As mentioned, “Class D” 415 reservoirs can be combined (at combination block 420) with “Class C” 412 reservoirs and classified as “Tier 3” 413. “Strategic” 416 reservoirs may be classified as “Tier 4” 417 reservoirs.

Accordingly, flow chart 400 illustrates one embodiment of a process for performing a RRA™ classification of petroleum reservoirs that classifies petroleum reservoirs into five classes (Class A through Class D and Strategic) and six tiers. Armed with these classifications, organizations can make decisions about where to allocate limited resources for reservoir development and maintenance.

Table 1 summarizes and details each of the five classes, and indicates the key metrics that would identify reservoirs with each class.

TABLE 1
Reservoir Classes

| Class | Key Metrics | Description |
|---|---|---|
| Class A: | High IRR | Class A fields represent low risk, high |
| High Profitability | | impact opportunities. The highest |
| | | performing reservoirs fall into this class. |
| | | With proper reservoir management, |
| | | Class A fields should typically provide |
| | | sustainable production in the long term. |
| Class B: | Medium IRR | Class B fields represent profitable |
| Medium Profitability, | High RDQI ™ | investment opportunities, but currently |
| High Recovery Potential | | perform beneath Class A fields. High |
| | | RDQI ™ scores indicate potential to be |
| | | elevated into Class A through |
| | | implementation of advanced technologies |
| | | and best practices in reservoir |
| | | management. |
| Class C: | Medium IRR | Class C fields represent profitable |
| Medium Profitability, | Low RDQI ™ | investment opportunities, but currently |
| Low Recovery Potential | | perform beneath Class A fields. Low |
| | | RDQI ™ scores generally infer that |
| | | opportunities may be more challenging. |
| Class D: | Low IRR | Class D fields may represent profitable |
| Low Profitability | Low ROIP | investment opportunities, but appear |
| | | marginal relative to the other classes. |
| Strategic: | Low IRR | Strategic fields may represent less |
| Low Profitability, | High ROIP | profitable investment opportunities relative |
| High Resource Size | | to the other classes. They may require |
| | | high efforts in technology, reservoir |
| | | management, and resource commitments |
| | | to be elevated to Class A. |

Table 2 summarizes and details each of the six tiers, the classes that make up each tier (if any), and high-level description of the reservoirs in each tier.

TABLE 2
Reservoir Tiers

| Tier | Class | Description |
|---|---|---|
| Tier 1 | Class A | Profitable reservoirs with the highest |
| | Class B | potential, including the largest reservoirs |
| | | in terms of ROIP. |
| Tier 2 | Class A | Profitable reservoirs with high recovery |
| | Class B | potential. While these reservoirs do not |
| | | have the largest ROIP, they may contain |
| | | significant potential and may be good |
| | | candidates for further study and |
| | | development. |
| Tier 3 | Class C | Medium profitability (IRR) reservoirs that |
| | Class D | have a low recovery potential (RDQI ™), |
| | | as well as low profitability (IRR) |
| | | reservoirs that have a low resource size |
| | | (ROIP). These reservoirs may have a |
| | | lower priority for further study and |
| | | development. |
| Tier 4 | Strategic | Reservoirs having a low profitability score |
| (Strategic) | | (IRR), but having a high resource size |
| | | (ROIP). These reservoirs may have a |
| | | lower priority for further study and |
| | | development. |
| Tier 5 | None | Reservoirs having a ROIP below a |
| (Not Analyzed) | | threshold that triggers analysis. These |
| | | reservoirs may have a lower priority for |
| | | further study and development. |
| Tier 6 | None | Non-producing reservoirs. These |
| (Shut-In) | | reservoirs may have a lower priority for |
| | | further study and development. |

As indicated in Table 2, some tiers represent an opportunity for further study. Further study may comprise an in-depth “Reservoir Management Rating” (RMR™) analysis. A comprehensive description of RMR™ is set forth in U.S. patent application Ser. No. 12/606,027, filed Oct. 26, 2009, and entitled “METHOD OF ASSESSING THE QUALITY OF RESERVOIR MANAGEMENT AND GENERATING A RESERVOIR MANAGEMENT RATING,” which is incorporated herein in its entirety by reference.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of classifying a petroleum reservoir using a reservoir ranking analysis to aid in reservoir management, planning, and/or development, the method comprising:
establishing a plurality of reservoir classification metrics for the petroleum reservoir, including at least one metric in each of the following classification categories: 1) resource size, 2) recovery potential, and 3) profitability;
generating or obtaining data relating to the plurality of reservoir classification metrics for the petroleum reservoir, at least some of the data being generated by at least one of (i) measuring a physical property of one or more producing oil wells and/or injector wells of the petroleum reservoir, (ii) taking and analyzing one or more core samples from the petroleum reservoir, or (iii) establishing a relationship between one or more different types of data from (i) or (ii);
classifying the petroleum reservoir as a high, medium, or low profitability reservoir based at least one metric in the profitability classification category; and
further classifying the petroleum reservoir based on at least one metric in one or more of the resource size classification category or the recovery potential classification category.

2. A method as in claim 1, the at least one metric in the resource size classification category including one or more of an Oil Initially In Place (OIIP) metric or a Remaining Oil in Place (ROIP) metric.

3. A method as in claim 1, the at least one metric in the recovery potential classification category including one or more of a Geo-Technical Index (GTI™) metric or a Reservoir Development Quality Index (RDQI™) metric.

4. A method as in claim 1, the at least one metric in the profitability classification category including one or more of an Internal Rate of Return (IRR) metric, a Return of Revenues (ROR) metric, or a Net Present Value (NPV) metric.

5. A method as in claim 1, wherein the petroleum reservoir is classified as belonging to one of the following classes:
a first class characterized by relatively high profitability;
a second class characterized by relatively medium profitability and relatively high recovery potential;
a third class characterized by relatively medium profitability and relatively low recovery potential;
a fourth class characterized by relatively low profitability and relatively low resource size; or
a fifth class characterized by relatively low profitability and relatively high resource size.

6. A method as in claim 1, wherein the petroleum reservoir is classified as a high profitability reservoir, the method further comprising classifying the petroleum reservoir based on at least one metric in the resource size classification category to categorize the petroleum reservoir as a tier 1 reservoir or a tier 2 reservoir.

7. A method as in claim 1, wherein the petroleum reservoir is classified as a medium profitability reservoir, the method further comprising classifying the petroleum reservoir based on at least one metric in the recovery potential classification category to categorize the petroleum reservoir as a high recovery potential or a low recovery potential reservoir.

8. A method as in claim 7, wherein the petroleum reservoir is also classified as a high recovery potential reservoir, the method further comprising classifying the petroleum reservoir based on at least one metric in the resource size classification category to categorize the petroleum reservoir as a tier 1 reservoir or a tier 2 reservoir.

9. A method as in claim 7, wherein the petroleum reservoir is classified as a low recovery potential reservoir, the method further comprising categorizing the petroleum reservoir as a tier 3 reservoir.

10. A method as in claim 1, wherein the petroleum reservoir is classified as a low profitability reservoir, the method further comprising classifying the petroleum reservoir based on at least one metric in the resource size classification category to categorize the petroleum reservoir as having high resource size or a low resource size.

11. A method as in claim 10, wherein the petroleum reservoir is categorized as having a low resource size, the method further comprising categorizing the petroleum reservoir as a tier 3 reservoir.

12. A method as in claim 10, wherein the petroleum reservoir is categorized as having a high resource size, the method further comprising categorizing the petroleum reservoir as a tier 4 reservoir.

13. A method as in claim 1, wherein the method is implemented at least in part by means of a computing system having a processor and system memory and which is configured to receive and analyze data relating to petroleum reservoir metrics.

14. A computer program product comprising one or more tangible computer readable media having executable instructions stored thereon which, when executed by a computer system having a processor and system memory, cause the computer system to perform the method of claim 13.

15. A method of classifying a petroleum reservoir using a reservoir ranking analysis to aid in reservoir management, planning, and/or development, the method comprising:
establishing a plurality of reservoir classification metrics for the petroleum reservoir, including at least one metric in each of the following classification categories: 1) resource size, 2) recovery potential, and 3) profitability,
the at least one metric in the resource size classification category including one or more of an Oil Initially In Place (OIIP) metric or a Remaining Oil in Place (ROIP) metric,
the at least one metric in the recovery potential classification category including one or more of a Geo-Technical Index (GTI™) metric or a Reservoir Development Quality Index (RDQI™) metric, and the at least one metric in the profitability classification category including one or more of an Internal Rate of Return (IRR) metric, a Return of Revenues (ROR) metric, or a Net Present Value (NPV) metric;
generating or obtaining data relating to the plurality of reservoir classification metrics for the petroleum reservoir, at least some of the data being generated by at least one of (i) measuring a physical property of one or more producing oil wells and/or injector wells of the petroleum reservoir, (ii) taking and analyzing one or more core samples from the petroleum reservoir, or (iii) establishing a relationship between one or more different types of data from (i) or (ii); and
classifying the petroleum reservoir as belonging to one of the following classes:
a first class characterized by relatively high profitability;
a second class characterized by relatively medium profitability and relatively high recovery potential;
a third class characterized by relatively medium profitability and relatively low recovery potential;
a fourth class characterized by relatively low profitability and relatively low resource size; or
a fifth class characterized by relatively low profitability and relatively high resource size.

16. In a computing system having a processor and system memory and which is configured to receive and analyze data relating to petroleum reservoir metrics, a method of classifying a petroleum reservoir using a reservoir ranking analysis, the method comprising:
establishing a plurality of reservoir classification metrics for the petroleum reservoir, including at least one metric in each of the following classification categories: 1) resource size, 2) recovery potential, and 3) profitability;
inputting into the computing system data relating to the plurality of reservoir classification metrics for the petroleum reservoir, at least some of the data being generated by at least one of (i) measuring a physical property of one or more producing oil wells and/or injector wells of the petroleum reservoir, (ii) taking and analyzing one or more core samples from the petroleum reservoir, or (iii) establishing a relationship between one or more different types of data from (i) or (ii); and
the processor at the computing system classifying the petroleum reservoir as a high, medium, or low profitability reservoir based at least one metric in the profitability classification category,
wherein when the processor classifies the petroleum reservoir as a high profitability reservoir or a low profitability reservoir, the processor further classifies the petroleum reservoir based on at least one metric in the resource size classification category; and
wherein when the processor classifies the petroleum reservoir as a medium profitability reservoir, the processor further classifies the petroleum reservoir based on at least one metric in the recovery potential classification category.

17. A method as in claim 16, the at least one metric in the resource size classification category including one or more of an Oil Initially In Place (OIIP) metric or a Remaining Oil in Place (ROIP) metric.

18. A method as in claim 16, the at least one metric in the recovery potential classification category including one or more of a Geo-Technical Index (GTI™) metric or a Reservoir Development Quality Index (RDQI™) metric.

19. A method as in claim 18, the at least one metric in the recovery potential classification category including a Geo-Technical Index (GTI™) metric, the GTI™ metric being calculated by the processor summing a compartmentalization factor of the petroleum reservoir, a transmissibility index of the petroleum reservoir, and a depth factor of the petroleum reservoir, each independently weighted by a corresponding weighting coefficient.

20. A method as in claim 18, the at least one metric in the recovery potential classification category including a Reservoir Development Quality Index (RDQI™) metric, the RDQI™ metric being calculated by the processor summing the GTI™ metric, crude quality of the petroleum reservoir, reserves of the petroleum reservoir, a well productivity index of the petroleum reservoir, and drilling costs of the petroleum reservoir, each independently weighted by a corresponding weighting coefficient.

21. A method as in claim 16, the at least one metric in the profitability classification category including one or more of an Internal Rate of Return (IRR) metric, a Return of Revenues (ROR) metric, or a Net Present Value (NPV) metric.

22. A method as in claim 16, further comprising the processor at the computing system applying a pre-filtering to the petroleum reservoir, including one or more of determining that the petroleum reservoir is active or that a resource size of the petroleum reservoir is above a threshold.

23. A method as in claim 19, the processor classifying the petroleum reservoir as belonging to one of the following classes:
a first class characterized by relatively high profitability;
a second class characterized by relatively medium profitability and relatively high recovery potential;
a third class characterized by relatively medium profitability and relatively low recovery potential;
a fourth class characterized by relatively low profitability and relatively low resource size; or
a fifth class characterized by relatively low profitability and relatively high resource size.

24. A computer program product comprising one or more tangible computer readable media having executable instructions stored thereon which, when executed by a computer system having a processor and system memory, cause the computer system to perform the method of claim 16.

25. A computer program product as in claim 24, the computer program product comprising a computer system composed of the processor and the system memory storing the executable instructions.
